(19) United States
(12) Patent Application Publication
(10) Pub. No.: US 2026/0010552 A1
(43) Pub. Date: Jan. 8, 2026

(54) METHOD FOR INFORMATION DISPLAY BASED ON LARGE MODEL, DEVICE, AND MEDIUM

(71) Applicant: BEIJING BAIDU NETCOM SCIENCE TECHNOLOGY CO., LTD., Beijing (CN)

(72) Inventors: Jingjia CAO, Beijing (CN); Jingfeng DENG, Beijing (CN); Jingbo ZHOU, Beijing (CN)

(21) Appl. No.: 19/331,593

(22) Filed: Sep. 17, 2025

(30) Foreign Application Priority Data
Jun. 17, 2025 (CN) 202510812045.7

(51) Int. Cl. G06F 16/334; G06F 16/335; G06F 40/30

(52) U.S. Cl. CPC G06F 16/334; G06F 16/335; G06F 40/30

(57) ABSTRACT

A method for information display based on a large model, a device, and a medium are provided. The method includes: in response to receiving a query question, performing matching between the query question and a field value set of a target data table corresponding to the query question to obtain at least one target field value group, where the target field value group includes target field values semantically associated with each other, and the target field values are configured to reduce a semantic deviation in the large model's understanding of the query question; invoking the large model according to a prompt information to generate a target query statement, where the prompt information is obtained based on the query question, the at least one target field value group, and a description information of the target data table; and displaying a query result obtained by executing the target query statement.

### CROSS-REFERENCE TO RELATED APPLICATION(S)

This application claims the benefit of Chinese Patent Application No. 202510812045.7 filed on Jun. 17, 2025, the whole disclosure of which is incorporated herein by reference.

### TECHNICAL FIELD

The present disclosure relates to the field of data processing technologies, in particular to the field of artificial intelligence technologies such as large models, natural language processing, and deep learning, and more specifically, to a method for information display based on a large model, a device, and a medium.

### BACKGROUND

With the advent of the era of big data, the demand for data query and analysis is increasing. Since data query methods based on structured query statements require a high level of professional knowledge from users, data query methods based on natural language have emerged in order to lower the threshold of data query. A data query method based on natural language allows users to raise query questions in natural language and automatically converts the query questions into query statements to perform data query and analysis.

### SUMMARY

The present disclosure provides a method for information display based on a large model, a device, and a medium.

According to an aspect of the present disclosure, a method for information display based on a large model is provided, including: in response to receiving a query question, performing matching between the query question and a field value set of a target data table corresponding to the query question to obtain at least one target field value group, where the target field value group includes a plurality of target field values semantically associated with each other, and the plurality of target field values are configured to reduce a semantic deviation in the large model's understanding of the query question; invoking the large model according to a prompt information to generate a target query statement, where the prompt information is obtained based on the query question, the at least one target field value group, and a description information of the target data table; and displaying a query result obtained by executing the target query statement.

According to another aspect of the present disclosure, an electronic device is provided, including: one or more processors; and a memory for storing one or more computer programs, where the one or more processors are configured to execute the one or more computer programs to implement steps in the method described above.

According to another aspect of the present disclosure, a computer-readable storage medium having computer programs or instructions therein is provided, where the computer programs or instructions are configured to, when executed by a process, implement steps in the method described above.

It should be understood that the content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

Through the following description of embodiments of the present disclosure with reference to the accompanying drawings, the above and other objectives, features, and advantages of the present disclosure will become more apparent. In the accompanying drawings:

FIG. 1 schematically shows a system architecture to which a method for information display based on a large model may be applied according to an embodiment of the present disclosure;

FIG. 2 schematically shows a flowchart of a method for information display based on a large model according to an embodiment of the present disclosure;

FIG. 3 schematically shows an example diagram of a process of constructing a field value set corresponding to a candidate data table according to an embodiment of the present disclosure;

FIG. 4 schematically shows an example diagram of a process of performing matching between a query question and a field value set of a target data table corresponding to the query question to obtain at least one target field value group according to an embodiment of the present disclosure;

FIG. 5 schematically shows an example diagram of a process of invoking a large model, according to a prompt information obtained based on a query question, at least one target field value group, and a description information of a target data table, to generate a target query statement according to an embodiment of the present disclosure;

FIG. 6 schematically shows a block diagram of an apparatus for information display based on a large model according to an embodiment of the present disclosure;

FIG. 7 schematically shows a structural block diagram of an agent of a large model according to an embodiment of the present disclosure; and

FIG. 8 schematically shows a block diagram of an electronic device suitable for implementing the method for information display based on a large model according to an embodiment of the present disclosure.

### DETAILED DESCRIPTION OF EMBODIMENTS

Embodiments of the present disclosure will now be described with reference to the accompanying drawings. It should be understood that these descriptions are merely exemplary and are not intended to limit the scope of the present disclosure. In the following detailed description, numerous specific details are set forth in order to provide a thorough understanding of embodiments of the present disclosure. However, it is evident that one or more embodiments may be implemented without these specific details. In addition, well-known structures and technologies are omitted in the following description to avoid unnecessarily obscuring the concepts of the present disclosure.

The terminology used herein is for the purpose of describing particular embodiments only and is not intended to limit the present disclosure. As used herein, the terms “include”, “including” and the like indicate the presence of stated features, steps, operations, and/or components but do not preclude the presence or addition of one or more other features, steps, operations, or components.

All terms (including technical and scientific terms) used herein have the meanings commonly understood by those skilled in the art, unless otherwise defined. It should be noted that the terminology used herein should be interpreted in a manner consistent with the context of this specification and should not be construed in an idealized or overly formal sense.

Where expressions such as “at least one of A, B, and C” are used, they should generally be interpreted according to the common understanding of those skilled in the art (for example, “a system having at least one of A, B, and C” may include, but is not limited to, a system having only A, only B, only C, both A and B, both A and C, both B and C, and/or A, B, and C together).

In a data query method based on natural language, a natural language query from a user needs to be converted into an executable query statement through a large model.

In this process, since some field values in the natural language query input by the user may differ from the field values in the database, such as synonyms, abbreviations, spelling errors, etc., it is difficult to effectively handle the association between the corresponding content in the natural language and the field values in the database. As a result, relevant information may not be accurately retrieved based on the generated query statement, which negatively affects the accuracy of data query and analysis as well as user experience.

To address this issue, embodiments of the present disclosure propose a solution for information display based on a large model. For example, in response to a query question being received, matching is performed between the query question and a field value set of a target data table corresponding to the query question to obtain at least one target field value group, where the target field value group includes a plurality of target field values semantically associated with each other, and the plurality of target field values are used to reduce a semantic deviation in the large model's understanding of the query question. According to a prompt information obtained based on the query question, the at least one target field value group, and a description information of the target data table, the large model is invoked to generate a target query statement. A query result obtained by executing the target query statement is then displayed.

According to embodiments of the present disclosure, since the query question is accurately matched with the target field value group, and the target field value group includes a plurality of target field values semantically associated with each other, the plurality of target field values may be used to reduce the semantic deviation in the large model's understanding of the query question. Accordingly, the accuracy and reliability in processing natural language query questions may be improved, and an accurate query statement may be generated, so that a desired query result may be quickly and accurately obtained and displayed for users, thereby enhancing user experience and improving the efficiency and quality of data query.

In technical solutions of the present disclosure, the collection, storage, use, processing, transmission, provision, disclosure and other processing of user personal information involved comply with provisions of relevant laws and regulations and do not violate public order and good custom.

In the technical solutions of the present disclosure, the acquisition or collection of user personal information has been authorized or allowed by users.

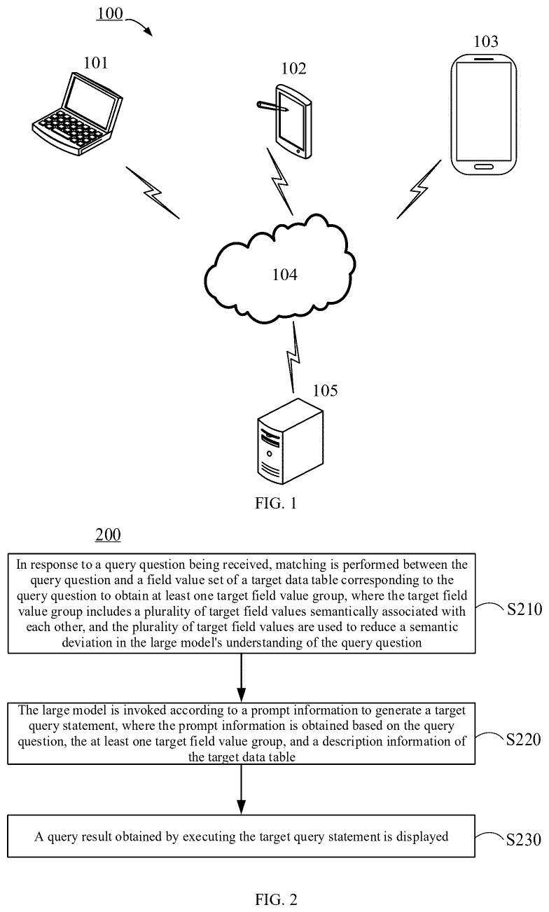

FIG. 1 schematically shows a system architecture to which a method for information display based on a large model may be applied according to an embodiment of the present disclosure. It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios.

As shown in FIG. 1, a system architecture 100 according to this embodiment may include a first terminal device 101, a second terminal device 102, a third terminal device 103, a network 104, and a server 105. The network 104 serves as a medium for providing a communication link between the first terminal device 101, the second terminal device 102, the third terminal device 103 and the server 105. The network 104 may include various types of connection, such as wired and/or wireless communication links, or optical fiber cables.

The first terminal device 101, the second terminal device 102, and the third terminal device 103 may be used by a user to interact with the server 105 through the network 104 to receive or send messages, etc. The first terminal device 101, the second terminal device 102, and the third terminal device 103 may be installed with various communication client applications, such as shopping applications, web browser applications, search applications, instant messaging tools, email clients, and/or social platform software, etc. (only for example).

The first terminal device 101, the second terminal device 102, and the third terminal device 103 may be various electronic devices having display screens and supporting web browsing, including but not limited to smart phones, tablet computers, laptop computers, and desktop computers, etc.

The server 105 may be a server providing various services, such as a background management server (only for example) that provides a support for content browsed by the user using the first terminal device 101, the second terminal device 102, and the third terminal device 103. The background management server may analyze and process received data such as a user request, and return a processing result (such as a web page, information, or data acquired or generated according to the user request) to the terminal devices.

It should be noted that the method for information display based on a large model provided in embodiments of the present disclosure may generally be performed by the server 105. Accordingly, the apparatus for information display based on a large model provided in embodiments of the present disclosure may be generally arranged in the server 105. The method for information display based on a large model provided in embodiments of the present disclosure may also be performed by a server or server cluster different from the server 105 and capable of communicating with the first terminal device 101, the second terminal device 102, the third terminal device 103, and/or the server 105. Accordingly, the apparatus for information display based on a large model provided in embodiments of the present disclosure may also be arranged in a server or server cluster different from the server 105 and capable of communicating with the first terminal device 101, the second terminal device 102, the third terminal device 103, and/or the server 105.

Alternatively, the method for information display based on a large model provided in embodiments of the present disclosure may be performed by the first terminal device 101, the second terminal device 102, or the third terminal device 103, or by other terminal devices different from the first terminal device 101, the second terminal device 102, or the third terminal device 103. Accordingly, the apparatus for information display based on a large model provided in embodiments of the present disclosure may be arranged in the first terminal device 101, the second terminal device 102, or the third terminal device 103, or in other terminal devices different from the first terminal device 101, the second terminal device 102, or the third terminal device 103.

It should be understood that the numbers of terminal devices, networks and servers shown in FIG. 1 are merely schematic. According to implementation needs, any number of terminal devices, networks and servers may be provided.

It should be noted that sequence numbers of operations in the following methods are merely used to represent the operations for ease of description, and should not be regarded as indicating an execution order of the operations. Unless explicitly stated, the method does not need to be performed exactly in the order shown.

The system architecture to which the method for information display based on a large model may be applied provided by the present disclosure has been described above. The process of information display based on a large model according to the present disclosure will now be further described with reference to FIG. 2 as an example.

FIG. 2 schematically shows a flowchart of a method for information display based on a large model according to an embodiment of the present disclosure.

As shown in FIG. 2, a method 200 for information display based on a large model includes operation S210 to operation S230.

In operation S210, in response to a query question being received, matching is performed between the query question and a field value set of a target data table corresponding to the query question to obtain at least one target field value group, where the target field value group includes a plurality of target field values semantically associated with each other, and the plurality of target field values are used to reduce a semantic deviation in the large model's understanding of the query question.

In operation S220, the large model is invoked according to a prompt information to generate a target query statement, where the prompt information is obtained based on the query question, the at least one target field value group, and a description information of the target data table.

In operation S230, a query result obtained by executing the target query statement is displayed.

Before performing the information display method provided by the present disclosure, a plurality of field value sets respectively corresponding to a plurality of candidate data tables may be generated in advance. For each candidate data table, the field value set may include a plurality of candidate fields and each candidate field value group corresponding to a candidate field. The candidate field value group may include at least one candidate field value, and the candidate field values in the same candidate field value group are semantically associated with each other.

In embodiment of the present disclosure, prior to acquiring user information, user consent or authorization may be obtained. For example, prior to operation S210, a request to acquire user information may be sent to the user. Operation S210 is performed upon obtaining user consent or authorization to acquire the user information.

The query question refers to an information expressed in the form of natural language that a user wants to query. After the query question is received, a target data table corresponding to the query question may be determined from a plurality of candidate data tables. The method for determining the target data table may be configured according to practical service requirements and is not limited herein.

After the target data table is determined, the query question may be matched with the field value set of the target data table to obtain at least one target field value group. The target field value group may include a plurality of target field values, and the target field values in the same target field value group are semantically associated with each other, thereby reducing the semantic deviation in the large model's understanding of the query question.

The method for determining the target field value group may be configured according to practical service requirements and is not limited herein. For example, it is possible to convert the query question and the field value set into high-dimensional vectors using a semantic embedding model, and calculate a cosine similarity for matching, so as to determine the target field value group. Alternatively, a rule-based matching method may be adopted, in which mapping rules between natural language terms and field values in the data tables are established in advance, and the terms in the query question are matched one by one according to the rules to determine the target field value group.

After at least one target field value group is obtained, a prompt information may be constructed based on the query question, the at least one target field value group, and the description information of the target data table. The prompt information is provided to the large model to assist in generating the target query statement. The description information of the target data table refers to descriptions of content, structure, and other related information of the target data table, such as the categories of fields included in the table and a range of data.

The prompt information may include the query question, the plurality of target field values in the target field value groups, a reference query statement, and other contents, so as to provide context and reference for the large model, enabling the large model to more accurately generate a target query statement that meets user requirements. The target query statement may accurately express user's data query requirements and may be executed in the database to obtain the data required by the user, and the query result may then be obtained and displayed.

The method for generating the target query statement may be configured according to practical service requirements and is not limited herein. For example, an enhanced prompt may be constructed by combining the selected target field value group with the query question and the description information of the target data table corresponding to the query question, and the enhanced prompt may be input to the large model to generate a target query statement for the query question. Alternatively, a template may be designed according to a semantic information of the query question, and specific elements in the query question and the corresponding elements in the target field value groups may be filled into the template to form a prompt information, which is then input to the large model to generate the target query statement.

The query result may be presented to the user in a user-friendly manner. For example, an appropriate chart type (such as a bar chart, line chart, pie chart, etc.) may be selected according to the type and characteristics of the query result, so as to intuitively present the data and assist the user in more clearly understanding and analyzing the data. In addition, while displaying the query result, at least one target field value group may also be displayed to enhance interpretability.

After the query statement is obtained, the query statement may be executed and the query result may be displayed. The display form of the query result may be configured according to practical service requirements and is not limited herein. For example, the display form of the query result may include at least one of: a table form, a chart form, or a text form. The table form may be used to display a structured query result. The chart form may include bar charts, line charts, pie charts, and scatter plots. A bar chart is used to present comparisons of data between different categories. A line chart is used to present the trend of data changing over time. A pie chart is used to present the proportion of parts relative to the whole. A scatter plot is used to present the relationship between two variables. The text form is used to provide a summary description of the query result.

According to embodiments of the present disclosure, since the query question is accurately matched with the target field value group, and the target field value group includes a plurality of target field values semantically associated with each other, the plurality of target field values may be used to reduce a semantic deviation in the large model's understanding of the query question. Accordingly, the accuracy and reliability of the large model in processing natural language query questions may be improved, and an accurate query statement may be generated, so that a required query result may be quickly and accurately obtained and displayed for users, thereby enhancing user experience and improving the efficiency and quality of data query.

In an embodiment, a semantic overlap degree between the plurality of target field values satisfies a predetermined overlap degree condition. The semantic overlap degree is an indicator for measuring a degree of semantic overlap between a plurality of target field values, that is, a degree of consistency in meaning between the plurality of target field values. The predetermined overlap degree condition refers to a standard set in advance for determining whether the semantic overlap degree between a plurality of field values meets the requirement. For example, the predetermined overlap degree condition may require that the semantic overlap degree reaches 0.8 or above.

The method for determining the semantic overlap degree may be configured according to practical service requirements and is not limited herein. For example, it is possible to convert the target field values into vectors using a semantic embedding model, and calculate a cosine similarity between the vectors to measure the semantic overlap degree. Alternatively, the semantic overlap degree of a plurality of field values may be determined subjectively by domain experts through manual annotation of semantic similarity.

The target field values may include at least one of: synonyms, abbreviations, short forms, or full forms. For example, for the target field value “net profit”, a target field value group may include “the amount of total current profit of the enterprise minus income tax”, “profit”, “Net Profit”, “P”, or the like. “Net Profit” may be understood as the full form of “net profit”, “P” may be understood as a short form or abbreviation of “net profit”, and “the amount of total current profit of the enterprise minus income tax” may be understood as a synonym of “net profit”.

According to embodiments of the present disclosure, by ensuring that the semantic overlap degree between the plurality of target field values satisfies the predetermined overlap degree condition, it is possible to capture the same or similar semantics represented by different expressions in a natural language query, so as to more accurately determine the correct target field value group and enhance the understanding of user intent, thereby effectively improving the accuracy of data query in semantic understanding, and contributing to the accuracy and reliability of the query result.

In an embodiment, a field value set includes a plurality of candidate fields in a candidate data table and each candidate field value group corresponding to a candidate field. The field value set corresponding to the candidate data table may be obtained by: performing a structured information extraction on the candidate data table to obtain a plurality of candidate fields and each candidate field value corresponding to a candidate field; and performing, for each candidate field, a semantic feature extraction on the plurality of candidate field values to obtain a candidate field value group, and taking the plurality of candidate fields and the candidate field value groups corresponding to the candidate fields as the field value set.

For each candidate data table, the structured information extraction refers to a process of extracting structured fields and corresponding field value information from the candidate data table. For example, it is possible to extract field names of the candidate fields and the corresponding candidate field values from the candidate data table through database query statements. The specific method for performing structured information extraction may be configured according to practical service requirements and is not limited herein.

In an example, it is possible to perform structured query and extraction on the candidate data table using tools or functions provided by a database management system. For example, a SELECT statement may be used to extract the field names of candidate fields and the corresponding candidate field values from the candidate data table. Alternatively, data mining technology may be adopted to mine structured field names of candidate fields and corresponding candidate field values from the candidate data table. For example, a clustering algorithm may be used to analyze the data in the candidate data table to extract potential field names of candidate fields and corresponding candidate field values.

For each candidate field value, the semantic feature extraction refers to a process of converting the candidate field value into a form that may represent its semantic features. For example, the candidate field value may be converted into a vector representation to reflect its semantic features. The specific method for performing semantic feature extraction may be configured according to practical service requirements and is not limited herein.

In an example, a semantic feature extraction may be performed on the candidate field values using a semantic embedding model to convert the candidate field values into vector representations to form a candidate field value group. For example, “net profit”, “Net Profit”, “P”, and “the amount of total current profit of the enterprise minus income tax” may be respectively converted into semantic features through a semantic embedding model to form a candidate field value group. Alternatively, a semantic feature extraction may be performed on the candidate field values by means of manual annotation and semantic encoding. For example, experts may annotate the semantics of candidate field values, and then convert the annotated values into specific semantic codes to form a candidate field value group.

According to embodiments of the present disclosure, by extracting and processing the candidate fields in the candidate data table and the corresponding candidate field values, a field value set containing rich semantic information may be effectively constructed, which provides a basis for subsequent query understanding and semantic matching. This allows more accurate understanding of user query intent during the process of data query based on the query question, thereby improving the accuracy and relevance of the query result and enhancing the performance and reliability in handling complex query tasks.

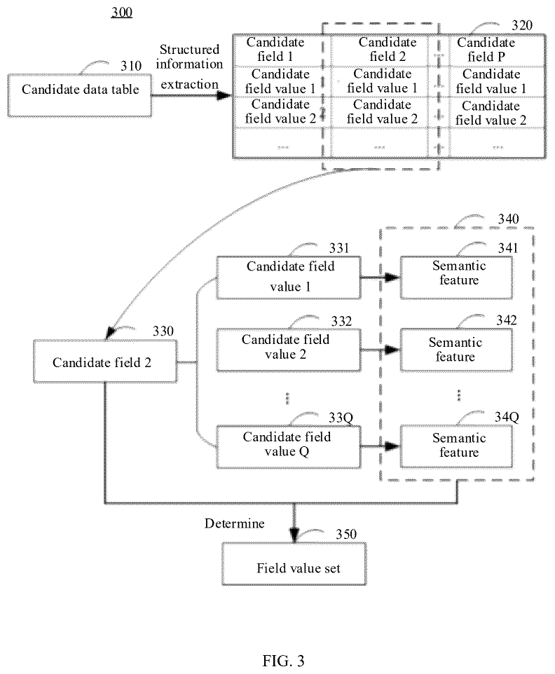

The process of constructing a field value set corresponding to a candidate data table will now be described by way of example with reference to FIG. 3.

FIG. 3 schematically shows an example diagram of a process of constructing a field value set corresponding to a candidate data table according to an embodiment of the present disclosure.

As shown in FIG. 3, in 300, for any candidate data table 310, a structured information extraction may be performed on the candidate data table 310 to obtain a structured information 320 of the candidate data table 310. The structured information 320 may include a plurality of candidate fields and each candidate field value of a candidate field, where each candidate field corresponds to a plurality of candidate field values. For example, the plurality of candidate fields may include candidate field 1, candidate field 2, . . . , candidate field P, where P is a positive integer.

Taking candidate field 2 (330) and a plurality of candidate field values corresponding to candidate field 2 (330) as an example, the process of constructing a field value set will now be described.

Candidate field 2 (330) may correspond to candidate field value 1, candidate field value 2, . . . , candidate field value Q, where Q is a positive integer. For each candidate field value, a semantic feature extraction may be performed on the candidate field value, and the semantic feature of the candidate field value thus obtained may be included in a candidate field value group 340 corresponding to candidate field 2 (330). For example, the candidate field value group 340 may include semantic feature 341 corresponding to candidate field value 1 (331), semantic feature 342 corresponding to candidate field value 2 (332), and semantic feature 34Q corresponding to candidate field value Q (33Q). On this basis, candidate field 2 (330) and the candidate field value group 340 may be taken as part of a field value set 350. In the same manner, each candidate field and the corresponding candidate field value group may be included in the field value set 350.

In an embodiment, operation S210 may include the following operations: performing semantic matching between the query question and the respective description information of the plurality of candidate data tables to determine the target data table for the query question; and performing semantic matching between the query question and the field value set corresponding to the target data table to obtain the at least one target field value group.

The specific method for performing semantic matching between the query question and the respective description information of the plurality of candidate data tables may be configured according to practical service requirements and is not limited herein. For example, it is possible to convert the query question and the description information of the candidate data tables into vectors using a semantic embedding model, calculate a similarity between the vector of the query question and the vector of each description information, and determine the target data table according to the similarity. Alternatively, it is possible to statistically determine the overlap degree and semantic relevance of keywords between the query question and the respective description information of the plurality of candidate data tables, and determine the target data table according to a matching degree obtained by combining the overlap degree and the semantic relevance.

The specific method for performing semantic matching between the query question and the field value set of the target data table may be configured according to practical service requirements and is not limited herein. For example, it is possible to convert the query question and the plurality of candidate field values of the candidate fields in the field value set into vectors by using a semantic embedding model, calculate a similarity between the vector of the query question and the vectors of the plurality of candidate field values of the candidate fields, and determine the target field value group in the target data table according to the similarity. Alternatively, it is possible to statistically determine the overlap degree and semantic relevance between the query question and the plurality of candidate field values of the candidate fields, and determine the target field value group in the target data table according to a matching degree obtained by combining the overlap degree and the semantic relevance.

According to embodiments of the present disclosure, by means of semantic matching technology, the target data table may be selected from a plurality of candidate data tables, and an appropriate target field value group may further be determined from the target data table, so that the target data table and the target field value group most relevant to the query question may be determined quickly and accurately, which not only improves query efficiency and reducing unnecessary time for data search and processing, but also enhances query accuracy and ensures consistency between the query result and user requirements.

In an embodiment, performing semantic matching between the query question and the field value set corresponding to the target data table to obtain at least one target field value group may include: performing, for each candidate field, semantic matching between the query question and the candidate field value group to obtain a matching degree between the candidate field and the query question; and determining the candidate field value groups for the candidate fields corresponding to top N matching degrees among a plurality of ranked matching degrees as the target field value groups, where N is a positive integer.

The target field value set may include a plurality of candidate fields and each candidate field value group for a candidate field. After the query question is received, semantic matching may be performed between the query question and the candidate field value groups for the candidate fields to obtain a matching degree between the candidate field and the query question. The matching degree is an indicator for measuring the semantic similarity between the candidate field and the query question. For example, the matching degree may range from 0 to 1, where a higher value of the matching degree indicates a greater similarity between the candidate field and the query question.

In an embodiment, the candidate field value group includes respective candidate semantic features of a plurality of candidate field values. Performing semantic matching between the query question and the candidate field value group for each candidate field to obtain the matching degree between the candidate field and the query question may include: determining a similarity between the semantic feature of the query question and each candidate semantic feature, so as to obtain a plurality of similarities; and determining the matching degree according to the plurality of similarities.

A semantic feature refers to an abstract representation of the core meaning and key information expressed by natural language text, which may reflect the semantic content and focus of the text. For example, it is possible to convert a natural language text into a high-dimensional vector by using a semantic embedding model to capture its semantic feature. Alternatively, a candidate field value may be represented as a vector by using a Bag-of-Words model or a TFIDF model, where each element in the vector represents a frequency or importance of a term, thereby obtaining candidate semantic features.

After the semantic feature of the query question is obtained, similarities between the semantic feature of the query question and the candidate semantic features may be determined respectively. The similarity is used to measure a degree of similarity between the semantic feature of the query question and the candidate semantic feature, and may be represented in the form of a numerical value, where a larger numerical value indicates a higher degree of similarity.

For each candidate field, it is possible to convert the query question and the candidate field values of the candidate field into high-dimensional vector representations by using a semantic embedding model, and then calculate the similarities between the semantic feature of the query question and the candidate semantic features. After the similarities corresponding to the candidate field values of the candidate field are obtained, a mean value of the plurality of similarities may be determined as the matching degree. In an example, the matching degree may be determined according to Equation (1) below.

$$sim ( q , f ) = \overline{cos ( {v}_{q} , {v}_{f} )} = \frac{1}{n} {\sum }_{i}^{n} \frac{{v}_{q} \cdot {v}_{fi}}{‖ {v}_{q} ‖ \times ‖ {v}_{fi} ‖} ; \qquad ( 1 )$$

where q represents a query question, f represents a candidate field value group, sim(q,f) represents a matching degree, v_{q} represents a semantic feature of the query question, v_{f} represents a semantic feature of the candidate field value group, c̅o̅s̅(̅v̅_̅{̅q̅}̅,̅v̅_̅{̅f̅}̅)̅ represents a mean value of cosine similarities, n represents the number of candidate field values in the candidate field value group, i represents an i^{th} candidate field value in the candidate field value group, and v_{fi} represents a semantic feature of the i^{th} candidate field value.

Alternatively, for each candidate field, after the similarities between the candidate field values of the candidate field and the query question are obtained, a maximum similarity among the plurality of similarities may be taken as the matching degree between the candidate field and the query question.

Alternatively, for each candidate field, after the similarities between the candidate field values of the candidate field and the query question are obtained, a median similarity among the plurality of similarities may be taken as the matching degree between the candidate field and the query question.

Alternatively, a weight may be preset for each candidate field value, and for each candidate field value, an intermediate similarity may be determined according to the weight and the similarity corresponding to the candidate field value. For each candidate field, the matching degree between the candidate field and the query question may be determined according to the intermediate similarities of the candidate field values.

Alternatively, a method combining keyword matching and semantic analysis may be adopted. Specifically, the query question and the candidate field values may first be subjected to word segmentation to extract keywords. Then, the matching degree of the keywords may be calculated, while a semantic similarity between the keywords may be calculated using a word vector model. The final similarity may then be obtained by combining the keyword matching degree and the semantic similarity.

According to embodiments of the present disclosure, by calculating the semantic similarity between the query question and the candidate field value group and determining the matching degree, the relevance between the candidate field and the query question may be effectively quantified, which facilitates accurately selecting the fields most relevant to the query question, thereby improving the capability of understanding the query question, and enabling generation of more accurate query results.

After the matching degree of each candidate field is obtained, the candidate fields may be ranked according to the matching degrees to obtain a plurality of ranked candidate fields. On this basis, the top N candidate field value groups among the candidate field value groups of the plurality of ranked candidate fields may be determined as the target field value groups. The target field value groups refer to the field value groups semantically most relevant to the query question.

According to embodiments of the present disclosure, by performing semantic matching and ranking-based filtering to calculate the matching degree and select the field value groups corresponding to the top N matching degrees, it is possible to effectively select the field value groups most relevant to the query question from a plurality of candidate fields, which not only enhances the semantic understanding capability for the query question, but also improves the efficiency of data query, so that users may quickly obtain the required information and user experience may be improved.

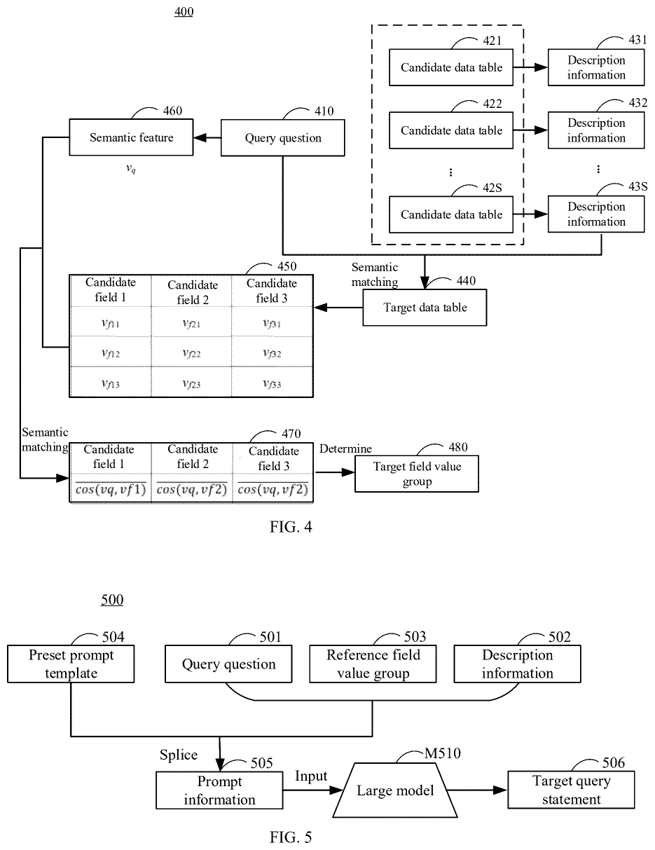

The process of determining the target field value group will now be described by way of example with reference to FIG. 4.

FIG. 4 schematically shows an example diagram of a process of performing matching between a query question and a field value set of a target data table corresponding to the query question to obtain at least one target field value group according to an embodiment of the present disclosure

As shown in FIG. 4, in 400, after a query question 410 is received, semantic matching may be performed between the query question 410 and respective description information of a plurality of candidate data tables to determine a target data table 440 for the query question 410.

For example, the plurality of candidate data tables may include candidate data table 421, candidate data table 422, . . . , candidate data table 42S, where S is a positive integer. After the query question 410 is received, the query question 410 may be semantically matched with description information 431 of candidate data table 421, description information 432 of candidate data table 422, . . . , description information 43S of candidate data table 42S, respectively, so as to determine the target data table 440.

After the target data table 440 is obtained, a field value set 450 of the target data table 440 may be acquired. The field value set 450 may include a plurality of candidate fields and each candidate field value group for a candidate field. For example, the plurality of candidate fields may include candidate field 1, candidate field 2, and candidate field 3. The candidate field value group for candidate field 1 may be {vf11, vf12, vf13}, the candidate field value group for candidate field 2 may be {vf21, vf22, vf23}, and the candidate field value group for candidate field 3 may be {vf31, vf32, vf33}. Here, vf11 refers to a candidate semantic feature of candidate field value 1 of candidate field 1, and other representations will not be described in detail here.

For each candidate field, a similarity between a semantic feature 460 of the query question 410 and each candidate semantic feature may be determined, so as to obtain a plurality of similarities. A matching degree between the candidate field and the query question may be determined according to the plurality of similarities, thereby obtaining matching degrees 470 between the candidate fields and the query question.

For example, for candidate field 1, it is possible to determine the similarity between semantic feature vq and candidate semantic feature vf11, the similarity between semantic feature vq and candidate semantic feature vf12, and the similarity between semantic feature vq and candidate semantic feature vf13. According to these three similarities, the matching degree c̅o̅s̅(̅v̅_̅{̅q̅}̅,̅v̅_̅{̅f̅1̅}̅)̅ between candidate field 1 and the query question 460 may be determined. Similarly, the matching degree c̅o̅s̅(̅v̅_̅{̅q̅}̅,̅v̅_̅{̅f̅2̅}̅)̅ between candidate field 2 and the query question 460 and the matching degree c̅o̅s̅(̅v̅_̅{̅q̅}̅,̅v̅_̅{̅f̅3̅}̅)̅ between candidate field 3 and the query question 460 may be determined.

After the respective matching degrees of the plurality of candidate fields are obtained, the matching degrees may be ranked to obtain a plurality of ranked matching degrees. The candidate field value groups of the candidate fields corresponding to the top N matching degrees among the plurality of ranked matching degrees may be determined as target field value groups 480.

In an embodiment, after the field value set of the candidate data table is obtained, the following operations may be further performed: in response to an update of a candidate data table, comparing the candidate data table before the update with the candidate data table after the update to determine at least one updated field; and updating the field value set corresponding to the candidate data table according to the at least one updated field, so as to obtain an updated field value set.

The method for monitoring whether a candidate data table has been updated and determining which specific fields have been updated in case of an update may be configured according to practical service requirements and is not limited herein. In an example, the monitoring and determination may be achieved by using a data comparison tool provided by a database management system. For example, the data comparison tool may compare the candidate data table before the update and the candidate data table after the update row by row and field by field, and the updated fields that have changed may be recorded. Alternatively, the monitoring and determination may be achieved through a change log of the database. For example, it is possible to analyze a field update information recorded in the change log to determine the updated field.

After the updated field is determined, it is possible to extract a new candidate field value from the updated candidate data table for the determined updated field, and partially update the old field value set. In an example, if the proportion of updated fields relative to all candidate fields in the candidate data table is greater than a predetermined threshold, it indicates that the content of the candidate data table has been significantly updated. In this case, the candidate data table may be wholly updated directly to the new candidate data table.

According to embodiments of the present disclosure, by promptly detecting updates of the candidate data tables, accurately determining the updated fields, and selectively updating the field value set, problems of inaccurate query results caused by data updates may be avoided, the efficiency of data updates may be improved, and unnecessary resource consumption may be reduced. Accordingly, the adaptability and performance in a dynamic data environment may be enhanced, and it may be ensured that the data on which the query question relies is always up-to-date, thereby contributing to the reliability and accuracy of data query.

In an embodiment, operation S220 may include the following operations: filtering the target field value groups by using the large model based on the query question and the description information to obtain at least one reference field value group; splicing the query question, the at least one reference field value group, and the description information of the data table based on a preset prompt template to obtain a prompt information; and invoking the large model based on the prompt information to generate a target query statement.

The description information refers to an information describing the content, structure, fields, and the like of the data table. After at least one target field value group is obtained, the recalled target field value groups may be provided to the large model, allowing the large model to infer which field value group should be selected. The specific method for filtering the target field value groups may be configured according to practical service requirements and is not limited herein.

In an example, the target field value groups may be filtered according to the query question and the description information by using the semantic understanding and generation capabilities of the large model. Alternatively, the target field value groups may be filtered according to keywords in the query question and keywords in the description information by using a rule-based matching method. For example, keywords may be extracted from the query question and the description information by means of keyword extraction technology, and then matched with the field values in the target field value groups to determine the reference field value group that meets the conditions.

The preset prompt template refers to a pre-designed format and structure for splicing prompt information, which specifies how to combine the reference field value group, the query question, and the description information of the data table into prompt information. The method for splicing the prompt information may be configured according to practical service requirements and is not limited herein.

In an example, the preset prompt template may be “Reference field value group: {ref_value}. The query question is: {question}, and the description information of the corresponding data table is: {table_desc}”. Specific contents may be filled according to the preset prompt template to obtain the prompt information. In another example, a combination of template filling and natural language generation may be adopted. For example, according to a logical structure of the preset prompt template, it is possible to organize the reference field value group, the query question, and the description information of the data table into a smooth and natural prompt text by using natural language generation technology. After the prompt information is obtained, the prompt information may be used to guide the large model to generate the target query statement.

According to embodiments of the present disclosure, by filtering the target field value groups using a large model, the semantic understanding capability may be enhanced, and by generating the prompt information in combination with the preset prompt template, the large model may be effectively guided to generate an accurate target query statement. This improves the understanding and response capability of a question-answering system with respect to user queries, and ensures the accuracy and relevance of query results.

The process of generating the target query statement will now be described by way of example with reference to FIG. 5.

FIG. 5 schematically shows an example diagram of a process of invoking a large model, according to a prompt information obtained based on a query question, at least one target field value group, and a description information of a target data table, so as to generate a target query statement according to an embodiment of the present disclosure.

As shown in FIG. 5, in 500, after target field value groups for a query question 501 are obtained, the target field value groups may be filtered by using a large model M510 based on a query question 501 and a description information 502, so as to obtain at least one reference field value group 503.

After the at least one reference field value group 503 is obtained, the query question 501, the at least one reference field value group 503, and the description information 502 may be spliced based on a preset prompt template 504 to obtain a prompt information 505. On this basis, the large model M510 may be invoked based on the prompt information 505 to generate a target query statement 506.

The above are merely exemplary embodiments, and the present disclosure is not limited thereto. Other methods for information display based on a large model known in the art may also be included, as long as a plurality of target field values may be used to reduce the semantic deviation in the large model's understanding of a query question, thereby improving the efficiency and quality of data querying.

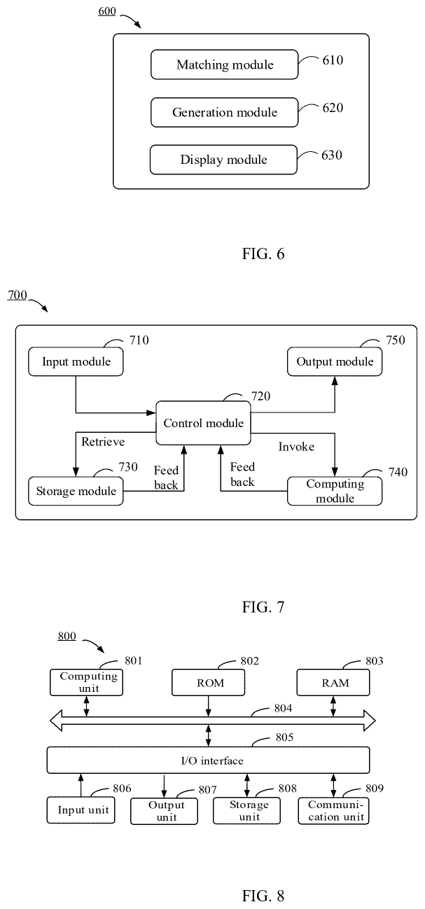

Based on the above-described method for information display based on a large model, the present disclosure further provides an apparatus for information display based on a large model. The apparatus will now be described in detail with reference to FIG. 6.

FIG. 6 schematically shows a block diagram of an apparatus for information display based on a large model according to an embodiment of the present disclosure.

As shown in FIG. 6, an apparatus 600 for information display based on a large model may include a matching module 610, a generation module 620, and a display module 630.

The matching module 610 is configured to, in response to receiving a query question, perform matching between the query question and a field value set of a target data table corresponding to the query question to obtain at least one target field value group, where the target field value group includes a plurality of target field values semantically associated with each other, and the plurality of target field values are configured to reduce a semantic deviation in the large model's understanding of the query question;

The generation module 620 is configured to invoke the large model according to a prompt information to generate a target query statement, where the prompt information is obtained based on the query question, the at least one target field value group, and a description information of the target data table.

The display module 630 is configured to display a query result obtained by executing the target query statement.

According to an embodiment of the present disclosure, the matching module 610 may include a first matching sub-module and a second matching sub-module.

The first matching sub-module is configured to perform semantic matching between the query question and the respective description information of a plurality of candidate data tables to determine the target data table for the query question.

The second matching sub-module is configured to perform semantic matching between the query question and the field value set corresponding to the target data table to obtain the at least one target field value group.

According to an embodiment of the present disclosure, the field value set includes a plurality of candidate fields in the candidate data tables and each candidate field value group corresponding to a candidate field.

According to an embodiment of the present disclosure, the field value set corresponding to the candidate data tables is obtained by: performing a structured information extraction on the candidate data tables to obtain the plurality of candidate fields and each candidate field value corresponding to a candidate field, where each candidate field corresponds to a plurality of candidate field values; and performing, for each candidate field, a semantic feature extraction on the plurality of candidate field values to obtain the candidate field value group, and including the plurality of candidate fields and each candidate field value group corresponding to a candidate field in the field value set.

According to an embodiment of the present disclosure, the second matching sub-module may include a matching unit and a determination unit.

The matching unit is configured to perform, for each candidate field, semantic matching between the query question and the candidate field value group to obtain a matching degree between the candidate field and the query question.

The determination unit is configured to determine the candidate field value groups for the candidate fields corresponding to top N matching degrees among a plurality of ranked matching degrees as the target field value groups, where N is a positive integer.

According to an embodiment of the present disclosure, the candidate field value group includes respective candidate semantic features of a plurality of candidate field values.

According to an embodiment of the present disclosure, for each candidate field, the matching unit may include a first determination sub-unit and a second determination sub-unit.

The first determination sub-unit is configured to determine a similarity between a semantic feature of the query question and each candidate semantic feature, so as to obtain a plurality of similarities.

The second determining sub-unit is configured to determine the matching degree according to the plurality of similarities.

According to an embodiment of the present disclosure, the apparatus 600 for information display based on a large model may further include a comparison module and an update module.

The comparison module is configured to, in response to an update of the candidate data table, compare the candidate data table before the update with the candidate data table after the update to determine at least one updated field.

The update module is configured to update the field value set corresponding to the candidate data table according to the at least one updated field, so as to obtain an updated field value set.

According to an embodiment of the present disclosure, the generation module 620 may include a filtering sub-module, a splicing sub-module, and a generation sub-module.

The filtering sub-module is configured to filter the target field value group by using the large model based on the query question and the description information to obtain at least one reference field value group.

The splicing sub-module is configured to splice the query question, the at least one reference field value group, and the description information based on a preset prompt template to obtain the prompt information.

The generation sub-module is configured to invoke the large model based on the prompt information to generate the target query statement.

According to an embodiment of the present disclosure, a semantic overlap degree between the plurality of target field values satisfies a predetermined overlap degree condition, and the target field values include at least one of: synonyms, abbreviations, short forms, or full forms.

FIG. 7 schematically shows a structural block diagram of an agent of a large model according to an embodiment of the present disclosure.

In an embodiment of the present disclosure, inspired by the von Neumann architecture in modern computer theory, as shown in FIG. 7, an AI agent 700 may include five core modules: an input module 710, a control module 720, a storage module 730, a computing module 740, and an output module 750.

The input module 710 is responsible for receiving or perceiving information such as queries, requests, instructions, signals, or data from the outside (such as users or the external environment) and converting them into a format that the AI agent 700 may understand and process. The input module 710 is a primary link for the AI agent 700 to interact with the outside world, enabling the AI agent 700 to efficiently and accurately obtain necessary “sensory” information from the outside world and make a response to the information.

In an example, the input module 710 may input the query question described above.

The control module 720 is the core support for the AI agent 700 to handle complex tasks. In the model training phase, the control module 720 may perform the above-described method for information display based on a large model.

In an example, the control module 720 may continuously interact with the storage module 730, the computing module 740, and/or the output module 750 during operation. However, it should be noted that in embodiments of the present disclosure, the control module 720 initiates communication with the storage module 730, the computing module 740, and/or the output module 750 as a single initiator, and there is no communication coupling between the storage module 730, the computing module 740, and the output module 750.

In an example, the performance of the control module 720 is closely related to the large model on which the AI agent 700 is based. In order to give full play to the capabilities of the large model, the internal structure of the control module 720 may be designed to be highly configurable and extensible, so as to meet various types of tasks and requirements in real scenarios.

The storage module 730 may be responsible for memorizing the field value sets corresponding to the candidate data tables. The above-described field value sets corresponding to the candidate data tables may be included in the storage module 730.

In an example, after receiving an evaluation request, the AI agent 700 may trigger the information display process based on a large model, acquire the field value sets corresponding to the candidate data tables from the storage module 730, and return them to the control module 720. Then, the control module 720 may transmit the returned field value sets corresponding to the candidate data tables to the output module 750.

The computing module 740 may be regarded as a predefined tool library. Tools for determining semantic features and tools for calculating similarity as described above may be included in the computing module 740.

In an example, when the AI agent 700 needs to process data, relevant tools may be invoked from the computing module 740 and fed back to the control module 720. Then, the control module 720 may use the fed-back tools to process the query question to obtain a query result. It may be understood that although the large model has excellent language understanding and generation capabilities, like humans, its capability to perform tasks are limited if without any tools. Once the AI agent 700 is endowed with the ability to invoke tools, it may accomplish tasks such as determining semantic features with the help of tools for determining semantic features and calculating similarity with the help of tools for calculating similarity.

In the model training phase, the output module 750 may output the above-mentioned query result.

The AI agent 700 according to embodiments of the present disclosure may simply and effectively improve the degree of intelligence, and enhance flexibility and versatility.

FIG. 8 schematically shows a block diagram of an electronic device suitable for implementing the method for information display based on a large model according to an embodiment of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the electronic device 800 includes a computing unit 801 which may perform various appropriate actions and processes according to a computer program stored in a read only memory (ROM) 802 or a computer program loaded from a storage unit 8012 into a random access memory (RAM) 803. In the RAM 803, various programs and data necessary for an operation of the electronic device 800 may also be stored. The computing unit 801, the ROM 802 and the RAM 803 are connected to each other through a bus 804. An input/output (I/O) interface 805 is also connected to the bus 804.

A plurality of components in the electronic device 800 are connected to the I/O interface 805, including: an input unit 806, such as a keyboard, or a mouse; an output unit 807, such as displays or speakers of various types; a storage unit 808, such as a disk, or an optical disc; and a communication unit 809, such as a network card, a modem, or a wireless communication transceiver. The communication unit 809 allows the electronic device 800 to exchange information/data with other devices through a computer network such as Internet and/or various telecommunication networks.

The computing unit 801 may be various general-purpose and/or dedicated processing assemblies having processing and computing capabilities. Some examples of the computing units 801 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 801 executes various methods and processes described above, such as the method for information display based on a large model. For example, in some embodiments, the method for information display based on a large model may be implemented as a computer software program which is tangibly embodied in a machine-readable medium, such as the storage unit 808. In some embodiments, the computer program may be partially or entirely loaded and/or installed in the electronic device 800 via the ROM 802 and/or the communication unit 809. The computer program, when loaded in the RAM 803 and executed by the computing unit 801, may execute one or more steps in the method for information display based on a large model described above. Alternatively, in other embodiments, the computing unit 801 may be used to perform the method for information display based on a large model by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the method for information display based on a large model of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method for information display based on a large model, comprising:
in response to receiving a query question, performing matching between the query question and a field value set of a target data table corresponding to the query question to obtain at least one target field value group, wherein the target field value group comprises a plurality of target field values semantically associated with each other, and the plurality of target field values are configured to reduce a semantic deviation in the large model's understanding of the query question;
invoking the large model according to a prompt information to generate a target query statement, wherein the prompt information is obtained based on the query question, the at least one target field value group, and a description information of the target data table; and
displaying a query result obtained by executing the target query statement.

2. The method of claim 1, wherein the performing matching between the query question and a field value set of a target data table corresponding to the query question to obtain at least one target field value group comprises:
performing semantic matching between the query question and the respective description information of a plurality of candidate data tables to determine the target data table for the query question; and
performing semantic matching between the query question and the field value set corresponding to the target data table to obtain the at least one target field value group.

3. The method of claim 2, wherein the field value set comprises a plurality of candidate fields in the candidate data tables and each candidate field value group corresponding to a candidate field, and the field value set corresponding to the candidate data tables is obtained by:
performing a structured information extraction on the candidate data tables to obtain the plurality of candidate fields and each candidate field value corresponding to a candidate field, wherein each candidate field corresponds to a plurality of candidate field values; and
performing, for each candidate field, a semantic feature extraction on the plurality of candidate field values to obtain the candidate field value group, and including the plurality of candidate fields and each candidate field value group corresponding to a candidate field in the field value set.

4. The method of claim 2, wherein the performing semantic matching between the query question and the field value set corresponding to the target data table to obtain the at least one target field value group comprises:
performing, for each candidate field, semantic matching between the query question and the candidate field value group to obtain a matching degree between the candidate field and the query question; and
determining the candidate field value groups for the candidate fields corresponding to top N matching degrees among a plurality of ranked matching degrees as the target field value groups, where N is a positive integer.

5. The method of claim 4, wherein the candidate field value group comprises respective candidate semantic features of a plurality of candidate field values, and the performing, for each candidate field, semantic matching between the query question and the candidate field value group to obtain a matching degree between the candidate field and the query question comprises:
determining a similarity between a semantic feature of the query question and each candidate semantic feature, so as to obtain a plurality of similarities; and
determining the matching degree according to the plurality of similarities.

6. The method of claim 2, further comprising:
in response to an update of the candidate data table, comparing the candidate data table before the update with the candidate data table after the update to determine at least one updated field; and
updating the field value set corresponding to the candidate data table according to the at least one updated field, so as to obtain an updated field value set.

7. The method of claim 1, wherein the invoking the large model according to a prompt information to generate a target query statement, wherein the prompt information is obtained based on the query question, the at least one target field value group, and a description information of the target data table comprises:
filtering the target field value group by using the large model based on the query question and the description information to obtain at least one reference field value group;
splicing the query question, the at least one reference field value group, and the description information based on a preset prompt template to obtain the prompt information; and
invoking the large model based on the prompt information to generate the target query statement.

8. The method of claim 1, wherein a semantic overlap degree between the plurality of target field values satisfies a predetermined overlap degree condition, and the target field values comprise at least one of: synonyms, abbreviations, short forms, or full forms.

9. An electronic device, comprising:
one or more processors; and
a memory for storing one or more computer programs, wherein the one or more processors are configured to execute the one or more computer programs to:
in response to receiving a query question, perform matching between the query question and a field value set of a target data table corresponding to the query question to obtain at least one target field value group, wherein the target field value group comprises a plurality of target field values semantically associated with each other, and the plurality of target field values are configured to reduce a semantic deviation in the large model's understanding of the query question;
invoke the large model according to a prompt information to generate a target query statement, wherein the prompt information is obtained based on the query question, the at least one target field value group, and a description information of the target data table; and
display a query result obtained by executing the target query statement.

10. The electronic device of claim 9, wherein the one or more processors are further configured to:
perform semantic matching between the query question and the respective description information of a plurality of candidate data tables to determine the target data table for the query question; and
perform semantic matching between the query question and the field value set corresponding to the target data table to obtain the at least one target field value group.

11. The electronic device of claim 10, wherein the field value set comprises a plurality of candidate fields in the candidate data tables and each candidate field value group corresponding to a candidate field, and wherein the one or more processors are further configured to:
perform a structured information extraction on the candidate data tables to obtain the plurality of candidate fields and each candidate field value corresponding to a candidate field, wherein each candidate field corresponds to a plurality of candidate field values; and
perform, for each candidate field, a semantic feature extraction on the plurality of candidate field values to obtain the candidate field value group, and include the plurality of candidate fields and each candidate field value group corresponding to a candidate field in the field value set.

12. The electronic device of claim 10, wherein the one or more processors are further configured to:
perform, for each candidate field, semantic matching between the query question and the candidate field value group to obtain a matching degree between the candidate field and the query question; and
determine the candidate field value groups for the candidate fields corresponding to top N matching degrees among a plurality of ranked matching degrees as the target field value groups, where N is a positive integer.

13. The electronic device of claim 12, wherein the candidate field value group comprises respective candidate semantic features of a plurality of candidate field values, and wherein the one or more processors are further configured to:
determine a similarity between a semantic feature of the query question and each candidate semantic feature, so as to obtain a plurality of similarities; and
determine the matching degree according to the plurality of similarities.

14. The electronic device of claim 10, wherein the one or more processors are further configured to:
in response to an update of the candidate data table, compare the candidate data table before the update with the candidate data table after the update to determine at least one updated field; and
update the field value set corresponding to the candidate data table according to the at least one updated field, so as to obtain an updated field value set.

15. The electronic device of claim 9, wherein the one or more processors are further configured to:
filter the target field value group by using the large model based on the query question and the description information to obtain at least one reference field value group;
splice the query question, the at least one reference field value group, and the description information based on a preset prompt template to obtain the prompt information; and
invoke the large model based on the prompt information to generate the target query statement.

16. The electronic device of claim 9, wherein a semantic overlap degree between the plurality of target field values satisfies a predetermined overlap degree condition, and the target field values comprise at least one of: synonyms, abbreviations, short forms, or full forms.

17. A non-transitory computer-readable storage medium having computer programs or instructions therein, wherein the computer programs or instructions, when executed by a process, are configured to:
in response to receiving a query question, perform matching between the query question and a field value set of a target data table corresponding to the query question to obtain at least one target field value group, wherein the target field value group comprises a plurality of target field values semantically associated with each other, and the plurality of target field values are configured to reduce a semantic deviation in the large model's understanding of the query question;
invoke the large model according to a prompt information to generate a target query statement, wherein the prompt information is obtained based on the query question, the at least one target field value group, and a description information of the target data table; and
display a query result obtained by executing the target query statement.

18. The non-transitory computer-readable storage medium of claim 17, wherein the computer programs or instructions, when executed by the process, are configured to:
perform semantic matching between the query question and the respective description information of a plurality of candidate data tables to determine the target data table for the query question; and
perform semantic matching between the query question and the field value set corresponding to the target data table to obtain the at least one target field value group.

19. The non-transitory computer-readable storage medium of claim 18, wherein the field value set comprises a plurality of candidate fields in the candidate data tables and each candidate field value group corresponding to a candidate field, and wherein the computer programs or instructions, when executed by the process, are configured to:
perform a structured information extraction on the candidate data tables to obtain the plurality of candidate fields and each candidate field value corresponding to a candidate field, wherein each candidate field corresponds to a plurality of candidate field values; and
perform, for each candidate field, a semantic feature extraction on the plurality of candidate field values to obtain the candidate field value group, and include the plurality of candidate fields and each candidate field value group corresponding to a candidate field in the field value set.

20. The non-transitory computer-readable storage medium of claim 18, wherein the computer programs or instructions, when executed by the process, are configured to:
perform, for each candidate field, semantic matching between the query question and the candidate field value group to obtain a matching degree between the candidate field and the query question; and
determine the candidate field value groups for the candidate fields corresponding to top N matching degrees among a plurality of ranked matching degrees as the target field value groups, where N is a positive integer.
